(19) United States
(12) Patent Application Publication
(10) Pub. No.: US 2015/0302714 A1
(43) Pub. Date: Oct. 22, 2015

(54) System and Method of Time-Augmented Annunciation of Signals

(71) Applicant: Honeywell International Inc., Morristown, NJ (US)

(72) Inventor: Timothy A. Rauworth, West Chicago, IL (US)

(73) Assignee: Honeywell International Inc., Morristown, NJ (US)

(21) Appl. No.: 14/257,371

(22) Filed: Apr. 21, 2014

(51) Int. Cl. G08B 21/02

(52) U.S. Cl. CPC G08B 21/02

(57) ABSTRACT

An apparatus to set an output window includes an ambient condition detector from which non-alarm messages can be output at a pre-determined time. The detector includes a real-time clock which can be set wirelessly by a real-time synchronizing message. A message emitting window can also be wirelessly pre-set. The non-alarm messages are emitted at times in the pre-set window.

### FIELD

The application pertains to informational signals emitted by ambient condition detectors. More particularly, the application pertains to such detectors where the time of emission of trouble, or other, signals can be adjusted by a user.

### BACKGROUND

Many products, such as smoke detectors and carbon monoxide detectors have trouble signals that are mandated by regulatory bodies. These signals at times annunciate in the middle of the night, causing end users distress, and damaging the reputation of the products. It has been known to provide delayed trouble signals that were solely detector based and not integrated into a system with a time-base.

Because of the importance of these signals in connection with normal detector operation it would be desirable to provide these signals in a timely fashion without upsetting or distressing the customer/user population.

### BRIEF DESCRIPTION OF THE DRAWINGS

FIG. 1 illustrates a system in accordance herewith;

FIG. 2 is a flow diagram of a process for setting a start/stop window;

FIG. 3 is a flow diagram of a process for setting a detector clock; and

FIG. 4 is a flow diagram of additional processing in accordance herewith.

### DETAILED DESCRIPTION

While disclosed embodiments can take many different forms, specific embodiments hereof are shown in the drawings and will be described herein in detail with the understanding that the present disclosure is to be considered as an exemplification of the principles hereof, as well as the best mode of practicing same, and is not intended to limit the claims hereof to the specific embodiment illustrated.

As discussed below, embodiments hereof prevent customers from being awakened by one or more trouble signals which might be emitted during hours of sleep. In embodiments hereof, a system connected detector receives current date and time information from a control unit, as well as preference information about the time of day that annunciations should begin.

Types of trouble signals that cause audible annunciation are predictable. These include, low battery warnings, detector dirty signals indicative of relatively high values of clear air output signals, and CO sensor end of life notices. These signals can safely be annunciated somewhat earlier than planned.

In disclosed embodiments, the respective sounders can be energized to emit a warning chirp, earlier than required at a time when the end user will not be disturbed, and will be more likely to service the unit. It will be understood that neither the types of detectors nor the non-alarm conditions being reported are limitations hereof.

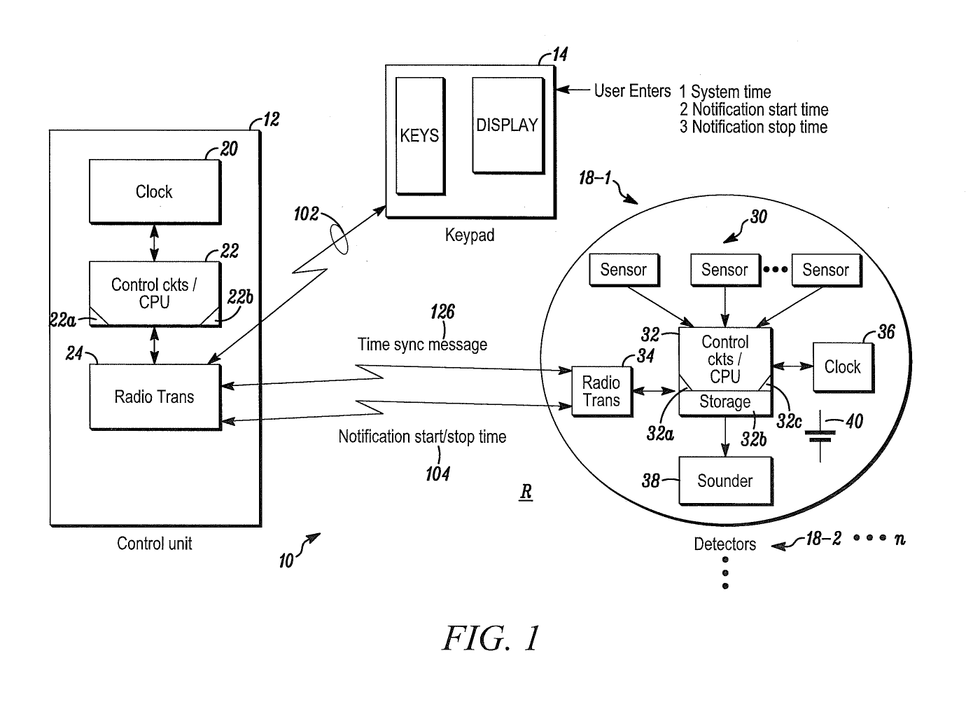

FIG. 1 illustrates a system 10 in accordance herewith. System 10 includes a control unit 12 which is in wired or, wireless communication with a manually operable key pad 14. Control unit 12 is also in wireless communication with one or more ambient condition detectors such as 18-1, -2 . . . -n which can be installed in a region R being monitored by system 10.

The control unit 12 can include a clock 20, control circuits 22 which could be implemented in part by a programmable control unit 22a which executes a plurality of pre-stored instructions 22b. The unit 12 can also include a wireless, radio, transceiver 24 which can communicate wirelessly with the keypad 14 and detectors 18-i.

Those of skill will understand that a variety of detectors come within the scope of the plurality 18. A representative detector 18-1 will be described and that description will be applicable to other detectors 18-2 . . . -n of the plurality.

Detector 18-1 can include one or more ambient condition sensors, illustrated by plurality 30. Sensors can, without limitation include smoke sensors, flame sensors, gas sensors, and the like without limitation. Detector 18-1 can also include control circuits, such as 32 which can include a programmable processor 32a, storage unit 32b, and executable instructions 32c. Control circuits 32 can be coupled to wireless transceiver 34, a clock circuit 36 and a sounder 38, to emit an audible alarm or non-alarm audible output. Detector 18-1 can be powered via a battery 40.

It will be understood that a variety of detector based, non-emergency indicating conditions such as low battery, increasing non-smoke output levels, or gas sensor end of life indications can be signaled audibly using sounder 38. Time intervals can be established for the generation of corresponding audio outputs to warn users in the vicinity that maintenance is needed for a detector such as 18-1 via the system 10. In another embodiment, keypad 14 can communicate directly with the detectors 18.

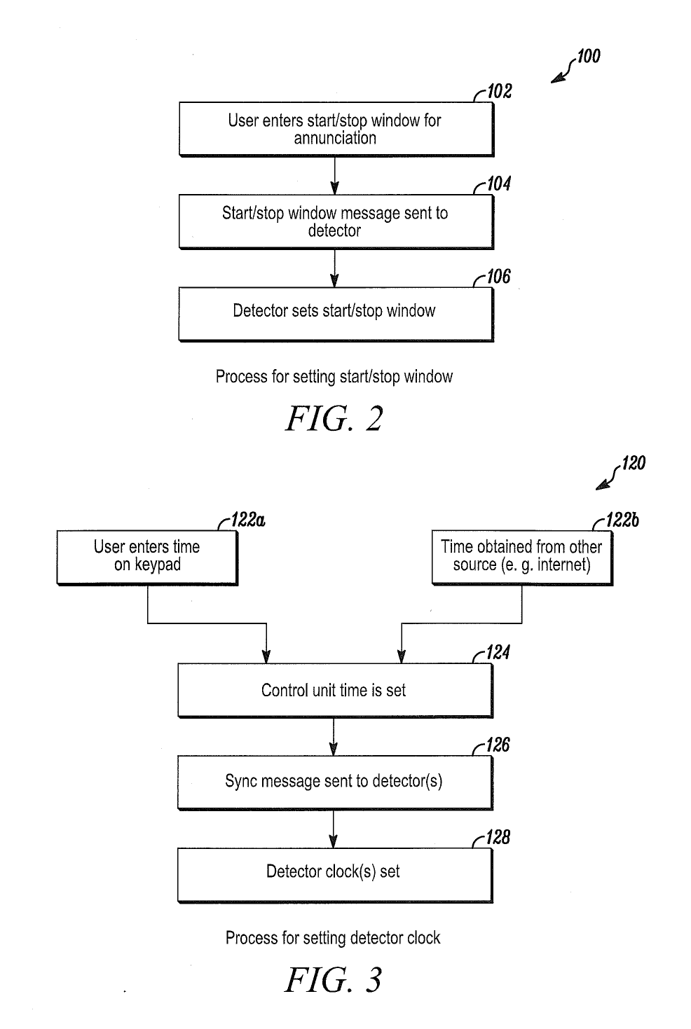

FIGS. 2-4 illustrate aspects of a process of adjusting detector annunciations times and time intervals. FIG. 2 illustrates aspects of a process 100 for setting a start/stop window. A user enters information as to a start/stop window for annunciation, as at 102. This information can differ between detectors.

A window defining message is sent to a selected detector, such as 18-1, as at 104. The selected detector stores information, for example in storage circuits 32b, related to the window, as at 106.

FIG. 3 illustrates aspects of a process 120 for setting a real-time clock, such as 36, for a selected detector such as 18-1. Either a user enters current time information on a keypad, such as keypad 14, as at 122a, or, current time information is obtained automatically from another source, as at 122b.

The control unit 12 sets the entered time on its clock, such as clock 20, as at 124. A synch message is sent to one or more of the detectors 18, as at 126. The selected detector(s) sets its respective clock, such as clock 36, as at 128 in response to the synch message 126.

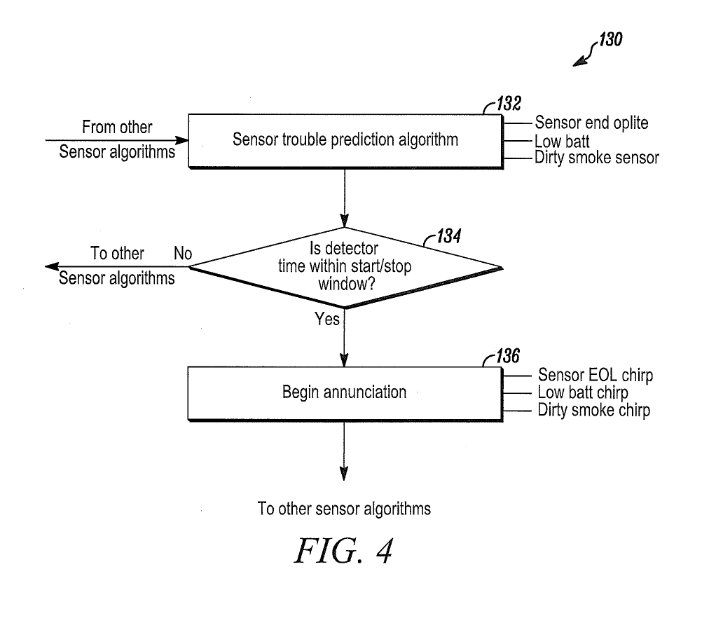

FIG. 4 illustrates processing 130 by a detector, such as detector 18-1. A trouble prediction process, or algorithm, is executed at a selected one of the detectors 18 to determine which, if any, non-emergency message should be issued, as at 132.

A detector based determination is then made to establish whether detector time, as on clock 36, is within the start/stop window previously stored in circuits 32b. If so, the appropriate output message is annunciated, as at 136, by the sounder or annunciator 38. The non-emergency trouble indicator can be emitted for a fixed period of time, or, until the time indicated by clock 36 exceeds the end of the pre-set window.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
a detector having, at least one ambient condition sensor, control circuits coupled to the sensor, a communications interface coupled to the control circuits, and a clock circuit coupled to the control circuits, the control circuits activate an output device, responsive to a predetermined, non-alarm, detector condition, in accordance with at least one of a preset time, or activation window.

2. An apparatus as in claim 1 which includes a manually operable element, separate from the detector, to provide a preset time, or window, to activate the output device in response to the predetermined, non-alarm detector condition.

3. An apparatus as in claim 2 which includes synchronization circuits, responsive to a synchronization message to set the clock to a predetermined time.

4. An apparatus as in claim 2 which includes an output device selected from a class that includes an audible output device or a visual output device.

5. An apparatus as in claim 2 where the control circuits establish at least one of an output start time or an output stop time.

6. An apparatus as in claim 5 where at least one of the start time, or the stop time is obtained from the preset time received from the element.

7. An apparatus as in claim 6 where the control circuits respond to a received wireless synchronization signal to set a time parameter in the clock.

8. An apparatus as in claim 7 which includes a control unit coupled wirelessly to the detector wherein the control unit responds to signals from the element providing the preset time to activate the output device.

9. An apparatus as in claim 8 wherein the control unit emits a synchronization signal to establish a time parameter at the detector.

10. An apparatus as in claim 9 wherein members of a plurality of detectors can be wirelessly communicated with by the control unit.

11. An apparatus as in claim 9 where the detector activates the output device to identify a predetermined non-alarm condition at the preset time.

12. An apparatus as in claim 11 wherein activation continues for a selected time interval.

13. An apparatus as in claim 12 wherein first and second different conditions are identified starting at first and second different times, or windows.

14. An apparatus as in claim 13 which includes a plurality of detectors in communication with the control unit and wherein at least some of the detectors identify non-alarm conditions at different predetermined times.

15. An apparatus as in claim 14 where some of the detectors include a first type of ambient condition sensor and others include a different type of sensor.

16. An apparatus comprising:
a detector having, at least one ambient condition sensor, control circuits coupled to the sensor, storage circuits coupled to the control circuits, and a clock circuit coupled to the control circuits, the control circuits activate an output device, responsive to a predetermined, non-alarm, detector condition, in accordance with at least one of a preset time, or activation window, and, a manually operable element, separate from the detector, to provide the preset time, or window, to activate the output device in response to the predetermined, non-alarm detector condition.

17. An apparatus as in claim 16 which includes a plurality of detectors wherein some of the detectors respond to smoke, or fire, and others respond to a selected gas and wherein the detectors include at least one of a wired or wireless communication interface.

18. An apparatus as in claim 17 where the control circuits establish at least one of an output start time or an output stop time wherein at least one of the start or stop times is stored in the storage circuits.

19. An apparatus as in claim 16 wherein the detector includes a real-time clock and where the control circuits respond to a received wireless synchronization signal to set a time parameter in the clock. 20, An apparatus to set an output window comprises an ambient condition detector from which non-alarm messages can be output at a pre-determined time, the detector includes a real-time clock which can be set wirelessly by a real-time synchronizing message, a message emitting window can also be wirelessly pre-set, and wherein, the non-alarm messages are emitted by the detector during times in the pre-set window.
